(19) United States
(12) Patent Application Publication
(10) Pub. No.: US 2023/0072414 A1
(43) Pub. Date: Mar. 9, 2023

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazuyuki INOUE, Nagoya-shi (JP); Yurika TANAKA, Yokosuka-shi (JP); Satoshi KOMAMINE, Nagoya-shi (JP); Go TANAKA, Toyota-shi (JP); Hiromitsu FUJII, Kariya-shi (JP)

(73) Assignee: TOYOTA JIDOSHA KABUSHIKI KAISHA, Toyota-shi (JP)

(21) Appl. No.: 17/850,106

(22) Filed: Jun. 27, 2022

(30) Foreign Application Priority Data
Sep. 3, 2021 (JP) 2021-144260

(51) Int. Cl. G08B 21/24; B60W 60/00

(52) U.S. Cl. CPC G08B 21/24; B60W 60/00256; B60W 2556/45

(57) ABSTRACT

A controller is provided which performs notifying a user when it is detected that baggage remains in a compartment after the user uses a service of keeping the baggage in a storage device which is mounted on a vehicle and which has a plurality of compartments in which the baggage can be deposited by the user.

### CROSS REFERENCE TO THE RELATED APPLICATION

This application claims the benefit of Japanese Patent Application No. 2021-144260, filed on Sep. 3, 2021, which is hereby incorporated by reference herein in its entirety.

### BACKGROUND

### Technical Field

The present disclosure relates to an information processing apparatus and an information processing method.

### Description of the Related Art

There has been known a technology in which a lock mechanism is provided in a baggage compartment of a train, and is locked and unlocked by identifying a person who has deposited baggage in the compartment based on images taken by a camera (see, for example, Patent Literature 1). In addition, there has also been known a technology in which when there are residual or remaining items such as forgotten items in a box of a locker, the items can be changed to another box (for example, see Patent Literature 2).

### CITATION LIST

### Patent Literature

Patent Literature 1: Japanese Patent Application Laid-Open Publication No. 2021-046015

Patent Literature 2: Japanese Patent Application Laid-Open Publication No. 2020-107223

### SUMMARY

An object of the present disclosure is to deliver or give baggage to a user at an early stage when the user forgets the baggage in a locker.

One aspect of the present disclosure is directed to an information processing apparatus including a controller configured to perform:

notifying a user when it is detected that baggage remains in a compartment after the user uses a service of keeping the baggage in a storage device which is mounted on a vehicle and which has a plurality of compartments in which the baggage can be deposited by the user.

Another aspect of the present disclosure is directed to an information processing method for causing a computer to perform;

notifying a user when it is detected that baggage remains in a compartment after the user uses a service of keeping the baggage in a storage device which is mounted on a vehicle and which has a plurality of compartments in which the baggage can be deposited by the user.

In addition, a further aspect of the present disclosure is directed to a program for causing a computer to perform processing in the above-mentioned information processing apparatus, or a storage medium storing this program in a non-transitory manner.

According to the present disclosure, it is possible to deliver baggage to a user at an early stage when the user forgets the baggage in a locker.

### BRIEF DESCRIPTION OF THE DRAWINGS

FIG. 1 is a view illustrating a schematic configuration of a system according to an embodiment;

FIG. 2 is a view illustrating an appearance of a locker;

FIG. 3 is a block diagram schematically illustrating an example of a configuration of each of a vehicle, a user terminal and a server, which together constitute the system according to the embodiment;

FIG. 4 is a diagram illustrating an example of a functional configuration of the server;

FIG. 5 is a view illustrating an example of a table configuration of a vehicle information DB;

FIG. 6 is a view illustrating an example of a table configuration of a baggage information DB;

FIG. 7 is a diagram illustrating a functional configuration of the vehicle;

FIG. 8 is a diagram illustrating a functional configuration of the user terminal;

FIG. 9 is an example of an image displayed on an output unit of the user terminal when there is something left behind;

FIG. 10 is a flowchart of baggage deposit and pick-up processing at the server according to a first embodiment;

FIG. 11 is a sequence diagram of processing of the entire system when there is something left behind in the locker;

FIG. 12 is a flowchart of forgotten item determination processing according to the first embodiment;

FIG. 13 is a sequence diagram of processing of the entire system when there is something left behind in the locker;

FIG. 14 is a flowchart of forgotten item determination processing according to a second embodiment;

FIG. 15 is a sequence diagram of processing of the entire system when there is something left behind in the locker;

FIG. 16 is an example of an image displayed on a screen of the user terminal that has received information about a delivery point;

FIG. 17 is another example of an image displayed on the screen of the user terminal that has received information about delivery points; and

FIG. 18 is a flowchart of forgotten item determination processing according to a third embodiment.

### DESCRIPTION OF THE EMBODIMENTS

An information processing apparatus, which is one aspect of the present disclosure, includes a controller. The controller is configured to notify a user when it is detected that baggage (or luggage) remains in a compartment after the user uses a service of keeping the baggage in a storage device which is mounted on a vehicle and which has a plurality of compartments in which the baggage can be deposited by the user.

The storage device, which is mounted on the vehicle, moves together with the movement or travel of the vehicle. Therefore, the user can call the storage device together with the vehicle when depositing or picking up the baggage. Therefore, the user does not have to travel a long distance when depositing or picking up the baggage. Since the storage device has a plurality of compartments, a plurality of pieces of baggage corresponding to a plurality of users can be deposited or stored. The controller provides a baggage deposit service, for example, by controlling the vehicle so as to deposit the baggage from the user and deliver the baggage to the user.

Here, if the user forgets a part of the baggage in the compartment when picking up the baggage from the compartment, the following user may not be able to use the compartment. If the number of compartments in which baggage can be deposited or stored decreases, the profit may decrease accordingly.

Therefore, when detecting that baggage remains in a compartment even after the user's use thereof is finished, the controller notifies the user to that effect. The notification to the user includes, for example, notification via a terminal of the user, and direct notification from the storage device to the user. The notification via the terminal of the user includes, for example, displaying characters (text) indicating that baggage remains on the terminal of the user, and generating sound or vibration. In addition, the notification from the storage device to the user includes, for example, sending a sound indicating that a lost property (or forgotten item) remains from the storage device. Here, note that when the storage device notifies the user, the vehicle may be caused to move or travel toward the current location of the user. That is, the vehicle may follow the user.

On the other hand, the vehicle may wait until the user returns at the point where the baggage was picked up. In other words, even if the user returns to the vehicle after noticing that he or she has forgotten something, the vehicle may be stopped and wait for the user to return to the vehicle, since it may be difficult for the user to reach the vehicle if the vehicle is moving. As described above, the baggage forgotten by the user can be delivered to the user at an early stage.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

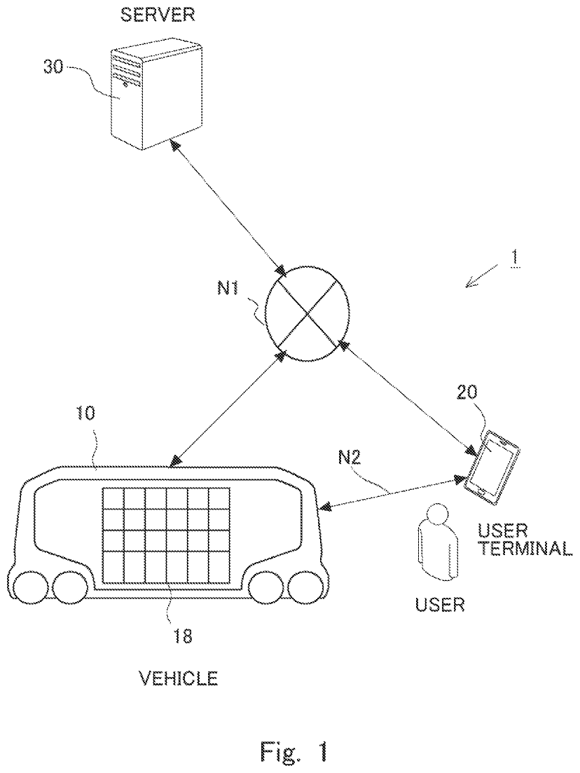

FIG. 1 is a view illustrating a schematic configuration of a system 1 according to an embodiment. The system 1 is a system in which a user can store baggage or the like in a vehicle 10 equipped with a locker 18. By calling the vehicle 10 via a server 30, the user can deposit and pick up the baggage at any point. The vehicle 10 is, for example, a vehicle capable of driving autonomously, but may be a vehicle capable of being driven manually by a driver, or may be a vehicle on which an operator who monitors the vehicle 10 or the locker 18 rides.

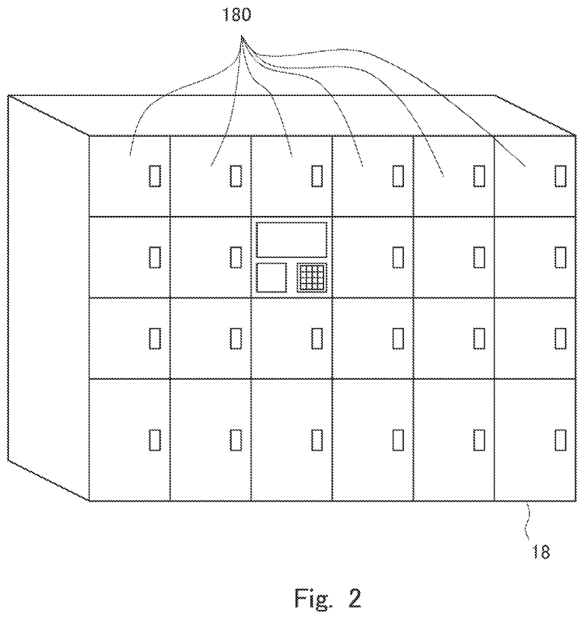

The locker 18 is a device that has a plurality of compartments, wherein baggage can be stored in each compartment. FIG. 2 illustrates an appearance of the locker 18. As illustrated, the rocker 18 is configured so that each compartment, box 180, can be accessed by a plurality of doors. A user of the system 1 can perform an unlocking operation of a designated box 180 by using a user terminal 20 or via an interface provided in the locker 18. The rocker 18 is mounted in a cabin of the vehicle 10. The locker 18 is an example of a storage device, and the box 180 is an example of a compartment.

The user is a user who uses the locker 18. The user terminal 20 is a terminal that is carried by the user. The user can call the vehicle 10, and can lock and unlock the locker 18 by executing a predetermined application installed on the user terminal 20.

The server 30 is a device that manages the operation of vehicles 10. When receiving a dispatch request for a vehicle 10 from the user terminal 20, the server 30 determines the vehicle 10 to be dispatched to the user and instructs the vehicle 10 to operate.

In addition, the server 30 is also a device that manages the locker 18. The server 30 notifies the user when the user has forgotten something in the locker 18. That is, when baggage remains in the box 180 after the user performs an operation for picking up the baggage from the locker 18, the server 30 executes processing for notifying the user. This process prompts the user to pick up the baggage.

The vehicle 10, the user terminal 20 and the server 30 are connected to one another by means of a network N1. The network N1 is, for example, a worldwide public communication network such as the Internet or the like, and a WAN (Wide Area Network) or other communication networks may be adopted. Also, the network N1 may include a telephone communication network such as a mobile phone network or the like, or a wireless communication network such as Wi-Fi (registered trademark) or the like. In addition, the locker 18 is connected to the user terminal 20 via a network N2 including short-range wireless communication or the like. The network N2 performs data communication using, for example, Bluetooth (registered trademark) LowEnergy, NFC (Near Field Communication), UWB (Ultra Wideband), Wi-Fi (registered trademark), or the like.

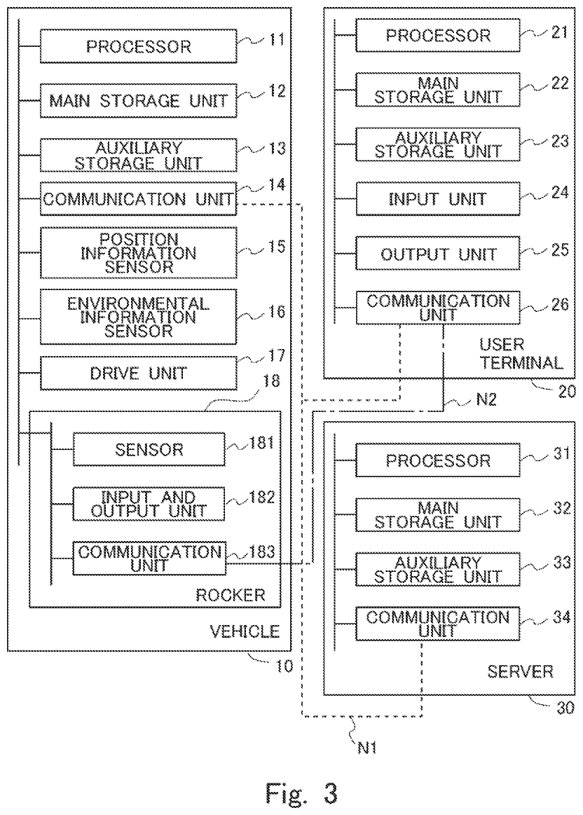

Hardware configurations and functional configurations of the vehicle 10, the user terminal 20 and the server 30 will be described based on FIG. 3. FIG. 3 is a block diagram schematically illustrating an example of a configuration of each of the vehicle 10, the user terminal 20 and the server 30, which together constitute the system 1 according to the present embodiment.

The server 30 has a configuration of a computer. The server 30 includes a processor 31, a main storage unit 32, an auxiliary storage unit 33, and a communication unit 34. These components are connected to one another by means of a bus. The processor 31 is an example of a controller,

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. As a result, the server 30 realizes functions that match predetermined purposes. The main storage unit 32 and the auxiliary storage unit 33 are computer readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the vehicle 10 and the user terminal 20 via the network N1. The communication unit 34 is, for example, a LAN (Local Area Network) interface board, a wireless communication circuit for wireless communication, or the like. The LAN interface board or the wireless communication circuit is connected to the network N1.

Next, the vehicle 10 is, for example, a moving object that is capable of autonomously traveling, and has a computer. The vehicle 10 includes a processor 11, a main storage unit 12, an auxiliary storage unit 13, a communication unit 14, a position information sensor 15, an environmental information sensor 16, a drive unit 17, and the locker 18. These components are connected to one another by means of a bus. The processor 11, the main storage unit 12, and the auxiliary storage unit 13 are the same as the processor 31, the main storage unit 32, and the auxiliary storage unit 33 of the server 30, respectively, and hence, the description thereof will be omitted.

The communication unit 14 is a communication means or unit for connecting the vehicle 10 to the network N1. The communication unit 14 is, for example, a circuit for communicating with other devices (e.g., the server 30 and the like) via the network N1 by making use of a mobile communication service (e.g., a telephone communication network such as 5G (5th Generation), 4G (4th Generation), 3G (3rd Generation), LTE (Long Term Evolution) or the like), or a wireless communication such as Wi-Fi (registered trademark), Bluetooth (registered trademark) or the like.

The position information sensor 15 obtains position information (e.g., latitude and longitude) of the vehicle 10 at a predetermined cycle. The position information sensor 15 is, for example, a GPS (Global Positioning System) receiver unit, a wireless communication unit or the like. The information obtained by the position information sensor 15 is recorded, for example, in the auxiliary storage unit 13 or the like and transmitted to the server 30.

The environmental information sensor 16 is a means or unit for sensing the state of the vehicle 10 or sensing the area around the vehicle 10. As a sensor for sensing the state of the vehicle 10, there is mentioned a gyro sensor, an acceleration sensor, an azimuth sensor, or the like. Also, as a sensor for sensing the area around the vehicle 10, there is mentioned a stereo camera, a laser scanner, a LIDAR, a radar, or the like.

The drive unit 17 is a device for driving the vehicle 10 based on control commands generated by the processor 11. The drive unit 17 is configured to include, for example, a plurality of motors or the like for driving rotors provided on the vehicle 10, so that the plurality of motors or the like are driven according to the control command to realize autonomous driving of the vehicle 10.

The locker 18 is a device that keeps the baggage (luggage) of the user. The locker 18 has a plurality of boxes 180 for storing the baggage of users, and each box 180 is provided with a sensor 181 for detecting the presence or absence of the baggage. In addition, the rocker 18 includes an input and output unit 182 and a communication unit 183. The sensor 181, the input and output unit 182, and the communication unit 183 are connected to the processor 11 and the like in the vehicle 10 by means of a bus

The sensor 181 is attached to the bottom of each box 180, for example, and includes a sensor capable of detecting a mass. That is, the presence or absence of baggage may be detected by detecting the mass of the baggage placed on the bottom surface of the box 180. As an alternative, the sensor 181 may include a sensor with a camera (image sensor), for example. That is, the baggage may be detected based on the image data captured by the camera. As another alternative, the sensor 181 may include a sensor that detects light shining into the box 180. That is, the presence or absence of the baggage may be detected by detecting the amount of light.

The input and output unit 182 is a unit that receives an input operation performed by a user and presents information to the user. In present embodiment, it is composed of a single touch panel display. In addition, the input and output unit 182 may also have a further means or unit for exchanging authentication information with the user terminal 20. For example, it may have a camera or the like for reading a two-dimensional bar code. Further, the input and output unit 182 may be equipped with a speaker that is used when notifying the user.

The communication unit 183 is a communication means or unit for connecting the locker 18 to the network N2. The communication unit 183 is a circuit for communicating with another device (e.g., the user terminal 20 or the like) via the network N2 by making use of a wireless communication network such as Bluetooth (registered trademark) LowEnergy, NFC (Near Field Communication), UWB (Ultra Wideband), Wi-Fi (registered trademark) or the like.

Now, the user terminal 20 will be described. The user terminal 20 is a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, and a communication unit 26. These components are connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted,

The input unit 24 is a means or unit that receives an input operation performed by the user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display.

The communication unit 26 is a communication means or unit for connecting the user terminal 20 to the network N1 or the network N2. The communication unit 26 is a circuit for communicating with another device (e.g., the vehicle 10, the locker 18, the server 30, or the like) via the network N1 or the network N2 by making use of a mobile communication service (e.g., a telephone communication network such as 5G (5th Generation), 4G (4th Generation), 3G (3rd Generation), LTE (Long Term Evolution) or the like), and/or a wireless communication network such as Wi-Fi (registered trademark), Bluetooth (registered trademark) LowEnergy, NEC (Near Field Communication), UWB (Ultra Wideband) or the like.

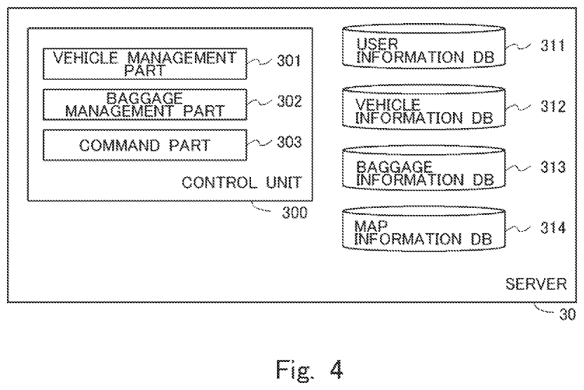

Now, the functions of the server 30 will be described. FIG. 4 is a diagram illustrating an example of a functional configuration of the server 30. The server 30 includes, as its functional components, a control unit 300, a user information DB 311, a vehicle information DB 312, a baggage information DB 313, and a map information DB 314. The processor 31 of the server 30 executes the processing of the control unit 300 by means of a computer program on the main storage unit 32. However, any of the individual functional components or a part of the processing thereof may be implemented by a hardware circuit. The control unit 300 includes a vehicle management part 301, a baggage management part 302 and a command part 303.

The user information DB 311, the vehicle information DB 312, the baggage information DB 313, and the map information DB 314 are built by a program of a database management system (DBMS) that is executed by the processor 31 to manage data stored in the auxiliary storage unit 33. The user information DB 311, the vehicle information DB 312, the baggage information DB 313, and the map information DB 314 are, for example, relational databases.

Here, note that any of the individual functional components of the server 30 or a part of the processing thereof may be executed by another or other computers connected to the network N1.

The vehicle management part 301 collects information about vehicles 10 and updates the vehicle information DB 312, which will be described below. To be specific, the vehicle management part 301 periodically communicates with a plurality of vehicles 10 and collects information on the vehicles 10 (hereinafter also referred to as vehicle information), The information thus collected is reflected in the vehicle information DB 312 described later.

The baggage management part 302 obtains a deposit request from a user who wants to deposit his or her baggage. The deposit request is information for calling a vehicle 10 to deposit the baggage at a point desired by the user. The deposit request is transmitted from the user terminal 20 to the server 30. The deposit request includes information about the user ID, deposit point, deposit date and time, baggage size, and the like. The user ID is an identifier unique to the user. User information (e.g., name, address, telephone number, e-mail address, etc.) corresponding to the user ID may be registered in advance by the user using the user terminal 20, or may be transmitted from the user terminal 20 together with the deposit request. This user information has been stored in the user information DB 311. The user information DB 311 is formed by storing the user information in the auxiliary storage unit 33 described above, where the user and the user information are associated with each other.

The deposit point is a point or location at which the user wants to deposit his or her baggage in the locker 18 of the vehicle 10, and is indicated, for example, by coordinates (latitude and longitude), an address, the name of a building, or the like. The deposit date and time is a date and time when the user wants to deposit the baggage in the locker of the vehicle 10. The deposit date and time may be designated as a time zone having a certain range.

In addition, the baggage management part 302 obtains a pick-up request from a user who wants to pick up his or her baggage. The pick-up request is information for calling the vehicle 10 carrying the baggage to a point desired by the user for the purpose of picking up the baggage. The pick-up request is transmitted from the user terminal 20 to the server 30. The pick-up request includes information on the user ID, the pick-up point, the pick-up date and time, and the like.

The pick-up point is a point or location at which the user wants to pick up his or her baggage from the locker 18 of the vehicle 10, and is indicated, for example, by coordinates (latitude and longitude), an address, the name of a building, or the like. The pick-up date and time is a date and time when the user wants to pick up the baggage from the locker 18 of the vehicle 10. Note that the pick-up date and time may be designated as a time zone with a certain range. In addition, the pick-up request may be transmitted from the user terminal 20 at the same time as the deposit request, or the pick-up request may be transmitted from the user terminal 20 after the deposit request.

The baggage management part 302 stores information included in the deposit request and information included in the pick-up request in the baggage information DB 313, which will be described later.

When receiving the deposit request or the pick-up request, the command part 303 determines a point at which the baggage is to be deposited or picked up (i.e., a point to which the vehicle 10 is to be dispatched; hereinafter, referred to as a dispatch point) and a date and time thereof (hereinafter, referred to as a dispatch date and time), and generates an operation command, which is a command for operating the vehicle 10. The operation command includes, for example, a route of the vehicle 10. The command part 303 generates the route based on the map information stored in the map information DB 314. For example, the command part 303 generates the operation command so that the vehicle 10 starts from the current location and travels through each dispatch point at the dispatch date and time. In addition, the operation command includes a command to keep the baggage from the user or a command to deliver the baggage to the user at each dispatch point.

For example, when receiving the deposit request from the user, the command part 303 selects a vehicle 10 that can be dispatched (hereinafter, also referred to as a dispatchable vehicle), based on information such as the deposit location, the deposit date and time, the size of the baggage included in the deposit request, and the like. The dispatchable vehicle 10 is a vehicle that has a vacant box 180 in which baggage of a corresponding size can be deposited, and can be moved to the deposit point at the deposit date and time. For example, a vehicle that has a reservation for depositing or picking up baggage at another place at the same date and time does not correspond to the dispatchable vehicle 10 that can move to the deposit point on the deposit date and time. Therefore, the vehicle 10 is selected in consideration of dispatch points and dispatch dates and times corresponding to other baggage. If there is no vehicle 10 that can be dispatched at the deposit date and time desired by the user, the user terminal 20 may be notified that the baggage cannot be deposited. At this time, the date and time when the baggage can be deposited at the deposit point may be notified to the user terminal 20.

Here, note that in the above description, the deposit request includes the deposit date and time, but the present invention is not limited to this, and the deposit date and time may be presented to the user from the server 30. For example, when the server 30 obtains the deposit point from the user terminal 20, it may obtain the date and time when the baggage can be deposited based on the reservation status of the box 180, and notify the user terminal 20 of the date and time when the baggage can be deposited. When there is more than one date and time available for deposit, the user may be presented with multiple available deposit dates and times. In this way, the user may be able to select from among a plurality of available deposit dates and times. Similarly, the server 30 may present a deposit point to the user without including the deposit point in the deposit request. In addition, as an alternative, the server 30 may present a deposit point and a deposit date and time to the user,

Moreover, for example, when receiving the pick-up request from the user, the command part 303 selects the vehicle 10 to be dispatched based on the information such as the user ID, the pick-up point, the pick-up date and time, etc., included in the pick-up request. The vehicle 10 to be dispatched at this time is a vehicle for which the user has already deposited his or her baggage. Therefore, the vehicle 10 in which the user has already deposited the baggage is identified or specified based on the user ID. Then, based on the pick-up point and the pick-up date and time included in the pick-up request, the command part 303 determines whether or not the vehicle 10 can be dispatched to the pick-up point at the pick-up date and time. Note that in cases where the vehicle 10 cannot be dispatched at the pick-up date and time desired by the user, the user terminal 20 may be notified that the baggage cannot be delivered at the pick-up point at the pick-up date and time. At this time, the user terminal 20 may be notified of another date and time when the baggage can be delivered at the pick-up point.

Here, note that in the above description, the pick-up date and time is included in the pick-up request, but the present invention is not limited to this, and the pick-up date and time may be presented to the user from the server 30. For example, when obtaining the pick-up point, the server 30 may obtain the available date and time at which the baggage can be picked up based on the reservation status of the box 180, and notify the user terminal 20 of the available date and time. When there are a plurality of dates and times available for pick-up, the plurality of available pick-up dates and times may be presented to the user. In this way, the user may be able to select from among the plurality of available pick-up dates and times. Similarly, the server 30 may present the pickup point to the user without including the pick-up point in the pick-up request. In addition, as an alternative, the server 30 may present the pick-up point and the pick-up date and time to the user.

Further, the baggage management part 302 obtains a detection value of the sensor 181 from the vehicle 10. The detection value of the sensor 181 may be included in the vehicle information periodically transmitted from the vehicle 10, for example. In addition, when the picking up of the baggage by the user is completed, the detection value of the sensor 181 of the box 180 from which the user has picked up the baggage may be transmitted from the vehicle 10 to the server 30. Then, when baggage or something is detected by the sensor 181 after the user has finished picking up the baggage, information for notifying that the baggage remains in the box 180 (i.e., there is something left behind (a forgotten item)) is transmitted to the user terminal 20.

Here, note that “the user has finished picking up the baggage” means, for example, that the user has opened and then closed the door of the box 180 at the time of picking up the baggage, or that the user has unlocked and then locked the box 180 at the time of picking up the baggage. Also, the information for notifying that the baggage remains in the box 180 is, for example, information for displaying an image indicating that there is a lost property (forgotten item) on an output unit 25 of the user terminal 20. This information may include a command or instruction to cause a predetermined application for using the locker 18 installed on the user terminal 20 to display an image indicating that there is a forgotten item. Alternatively, the information may include a command or instruction to display an image indicating that there is a forgotten item, on the output unit 25 of the user terminal 20 by using e-mail or push notification. In addition, this information may include a command or instruction for causing the user terminal 20 to generate a warning sound, voice, vibration, or the like, instead of or together with the image.

The baggage management part 302 stores information about forgetting to take the baggage corresponding to the box 180 in the baggage information DB 313, which will be described later.

In addition, the command part 303 restricts the movement of the vehicle 10 when there is a forgotten item in the box 180. For example, the vehicle 10 is kept stopped until the user returns to take the forgotten item. Thus, the user can easily find the vehicle 10. In cases where the locker 18 is located in the vehicle cabin, the door of the vehicle 10 may be closed and locked until the user returns to retrieve the forgotten item. Thus, the use of the locker 18 by other users is limited. However, there may be cases where the user does not return to retrieve the forgotten item. Therefore, the baggage management part 302 may move the vehicle 10, for example, in cases where the user does not return to the vehicle 10 after a predetermined period of time has passed since the user closed the box 180. At this time, the vehicle may travel toward a deposit point or a pick-up point of the next user, or may move toward a management center that manages the forgotten item.

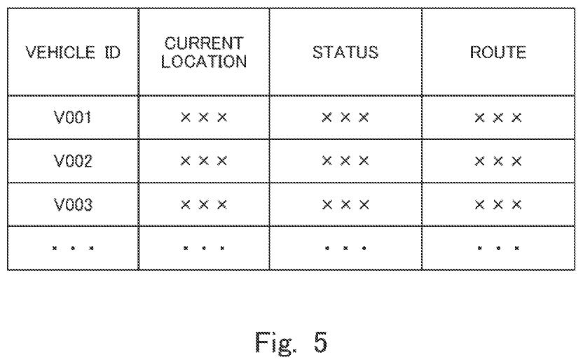

Next, the configuration of vehicle information stored in the vehicle information DB 312 will be described based on FIG. 5. FIG. 5 is a view illustrating an example of a table configuration of the vehicle information DB 312. A vehicle information table has fields for vehicle ID, current location, status and route. In the vehicle ID field, information that can identify each vehicle (vehicle ID) is entered. A vehicle ID is assigned to each vehicle, for example, by the vehicle management part 301. In the current location field, information about the current position or location of each vehicle 10 (position information) is entered. The current location of each vehicle 10 is detected by the position information sensor 15 of the vehicle 10, and transmitted to the server 30.

In the status field, data representing the current state of each vehicle 10 is stored. Specifically, information about the remaining battery capacity of each vehicle 10 or the distance that can be traveled is stored. In the route field, information about the route of each vehicle 10 is entered.

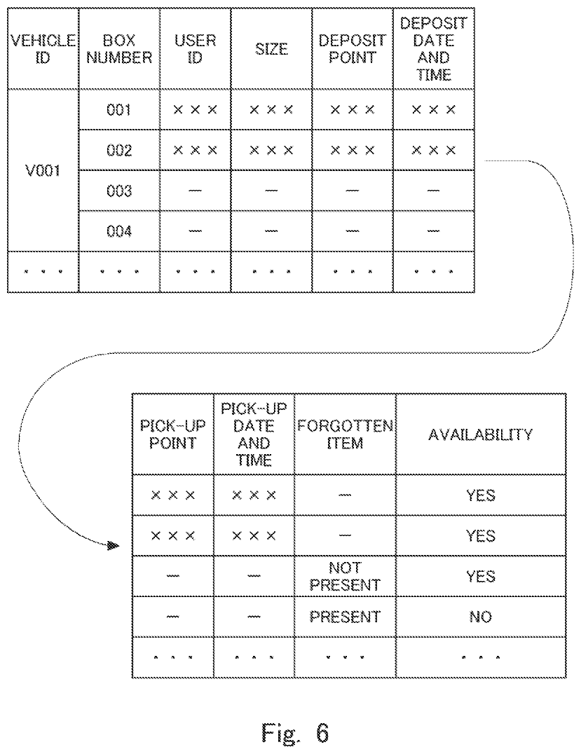

Next, the configuration of baggage information stored in the baggage information DB 313 will be described based on FIG, 6, FIG. 6 illustrates an example of a table configuration of the baggage information DB 313. The baggage information table has fields of vehicle ID, box number, user ID, size, deposit point, deposit date and time, pick-up point, pick-up date and time, forgotten item, and availability. In the vehicle ID field, information that can identify each vehicle (vehicle ID) is entered. In the box number field, information that can identify the box 180 (box number) is entered. In the user ID field, information that can identify the user who deposits the baggage (user ID) is entered. In the size field, information about the size of the baggage is entered. For example, the size may be indicated by the dimensions of length, width, and depth, or by predefined dimensions such as large, medium, and small.

In the deposit point field, information about a point where the user will deposit the baggage is entered. In the deposit point field, information is entered about a point that can be the destination of the vehicle 10 when the user deposits the baggage in the locker 18 of the vehicle 10, for example, coordinates, an address, a name of a building or the like. In the deposit date and time field, information about the date and time when the user deposits the baggage is entered. In the pick-up point field, information about a point where the user will pick up the baggage is entered. In the pick-up point field, information is entered about a point that can be the destination of the vehicle 10 when the user picks up the baggage in the locker 18 of the vehicle 10, for example, coordinates, an address, a name of a building or the like. In the pick-up date and time field, information about a date and time at which the user will pick up the baggage is entered.

In the forgotten item field, information about whether there is a lost (or forgotten) item is entered. When there is a forgotten item, “PRESENT” is entered, whereas when there is not, “NOT PRESENT” is entered. Also, nothing is entered in the forgotten item field while a box 180 is being used. In the availability field, information about whether or not each box 180 is available is entered. “Yes” is entered in an available box 180, whereas “NO” is entered in an unavailable box 180. For example, since the use of a box 180 with a forgotten item therein is prohibited, “NO” is entered in the availability field for the box. On the other hand, “YES” is entered in the availability field corresponding to a box 180 that has no forgotten item and a box 180 that is currently in use.

The map information DB 314 stores, as map information, for example, link data about roads (links), node data about node points, intersection data about each intersection, search data to search routes, facility data about facilities, search data to search points, etc. In addition, it may also store information about a speed limit or the like corresponding to each road or information about an attribute of each road.

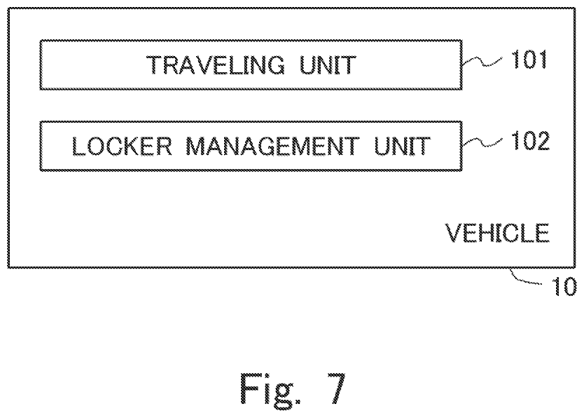

Now, the functions of the vehicle 10 will be described. FIG. 7 is a view illustrating a functional configuration of the vehicle 10. The vehicle 10 includes, as its functional components, a traveling unit 101 and a locker management unit 102. The processor 11 of the vehicle 10 executes the processing of the traveling unit 101 and the locker management unit 102 by a computer program on the main storage unit 12. However, any of the individual functional components or a part of the processing thereof may be implemented by a hardware circuit. Here, note that any of the individual functional components of the vehicle 10 or a part of the processing thereof may be executed by another or other computers connected to the network N1.

The traveling unit 101 controls traveling of the vehicle 10 during autonomous traveling of the vehicle 10. The traveling unit 101 generates control commands for controlling the drive unit 17 by using the data detected by the environmental information sensor 16. The traveling unit 101 controls, for example, the speed, the steering angle, and the like of the vehicle 10 by controlling a plurality of motors to generate a difference in the rotational speed of a plurality of rotors.

For example, the traveling unit 101 generates a travel trajectory of the vehicle 10 based on the data detected by the environmental information sensor 16, and controls the drive unit 17 so that the vehicle 10 travels along the travel trajectory. Here, note that as a method of causing the vehicle 10 to travel in an autonomous manner, there can be adopted a known method. The traveling unit 101 may perform feedback control based on the detection value of the environmental information sensor 16 during autonomous traveling. The traveling unit 101 controls the drive unit 17 so that the vehicle 10 autonomously travels around a predetermined route. This route is included in the operation command transmitted from the server 30.

For example, the traveling unit 101 causes the vehicle 10 to travel based on the travel route and the destination included in the operation command received from the server 30. When there is a deposit request or a pick-up request, the dispatch point becomes the destination. Then, the vehicle 10 is stopped at the dispatch point for the user to deposit or pick up the baggage.

The traveling unit 101 periodically transmits information about the vehicle 10 to the server 30. The traveling unit 101 transmits information about the current location and the remaining battery capacity obtained by the position information sensor 15 to the server 30 as information about the vehicle 10.

In addition, the locker management unit 102 performs authentication of the user terminal 20 of the user who deposits or picks up the baggage, locking and unlocking of the box 180, detection of forgotten items, and the like. The locker management unit 102 obtains the authentication information of the user terminal 20 from the server 30 via the network N1. Moreover, the locker management unit 102 establishes communication with the user terminal 20 via the network N2 to authenticate the user terminal 20. For example, when the authentication information obtained from the server 30 matches the authentication information obtained from the user terminal 20, the authentication of the user terminal 20 is successful.

When the authentication of the user terminal 20 is successful, the locker management unit 102 unlocks and opens a box 180 corresponding to the size of the baggage entered by the user. Thereafter, when the user closes the door of the box 180, the box 180 is locked, and the server 30 is notified that the user has deposited the baggage. As an alternative, the user may be authenticated according to the information entered into the input and output unit 182 by the user. For example, when a password entered into the input and output unit 182 by the user matches a password obtained from the server 30, the authentication is successful. This password may be determined by the server 30. Alternatively, the password entered into the user terminal 20 by the user may be transmitted from the user terminal 20 to the server 30.

Similarly, in the case of picking up the baggage, the locker management unit 102 obtains the authentication information of the user terminal 20 from the server 30 via the network N1. Moreover, the locker management unit 102 establishes communication with the user terminal 20 via the network N2 to authenticate the user. For example, when the authentication information obtained from the server 30 matches the authentication information obtained from the user terminal 20, the authentication of the user is successful. When the authentication of the user is successful, the box 180 in which the user deposits the baggage is unlocked and opened. The box number of a box in which the user deposited the baggage may be obtained from the server 30. Alternatively, when the user deposits the baggage, the box number of a box in which the user deposits the baggage may be stored in the auxiliary storage unit 13 of the vehicle 10.

Further, the locker management unit 102 may transmit the detection value of the sensor 181 after the user has picked up the baggage to the server 30 via the network N1. In this case, the locker management unit 102 may transmit the detection value of the sensor 181 corresponding to the box 180 in which the user has picked up the baggage. Note that as an alternative, the locker management unit 102 may periodically transmit the detection value of the sensor 181 to the server 30 via the network N1. In this case, the detection values of all the sensors 181 may be transmitted. As a result, the use of a predetermined box 180 may be prohibited by the server 30. In this case, too, for example, unlocking of the box 180, which has been prohibited from being used, is restricted based on a command or instruction from the server 30. Since the box number of the box 180 in which the user deposits the baggage is managed by the server 30, the server 30 manages so that the user does not deposit the baggage in the box 180 whose use is prohibited. In addition, in cases where there is something left behind, the server 30 may instruct the vehicle to stop there.

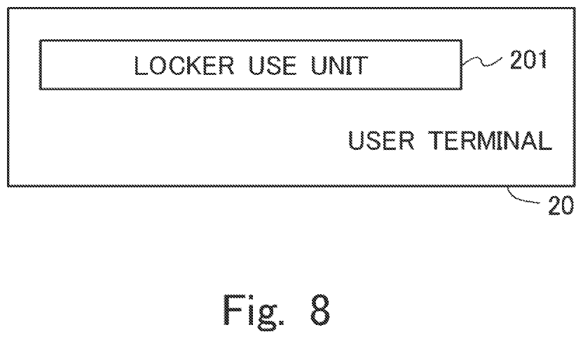

Next, the functions of the user terminal 20 will be described. FIG. 8 is a diagram illustrating a functional configuration of the user terminal 20. The user terminal 20 has a locker use unit 201 as its functional component. The processor 21 of the user terminal 20 executes the processing of the locker use unit 201 by a computer program on the main storage unit 22. However, a part of the processing of the locker use unit 201 may be executed by a hardware circuit. Note that a part of the processing of the locker use unit 201 may be executed by another computer connected to the network N1.

The locker use unit 201 generates a deposit request and a pick-up request according to an input to the input unit 24 of the user terminal 20. The locker use unit 201 displays a screen for using the locker 18 on the output unit 25. There, for example, a button is displayed together with words “DEPOSIT” and “PICK-UP”.

When the user taps the “DEPOSIT” button, the locker use unit 201 prompts the user to enter user information. Note that once the user information is entered, the information may be stored in the auxiliary storage unit 23, and thereafter, the locker 18 may be used only by entering a password, for example. The user enters or inputs a deposit point, a deposit date and time, an address, a name, a phone number, an e-mail address, and the like through the input unit 24. Upon completion of the user's input, the locker use unit 201 generates a deposit request and transmits it to the server 30 via the network N1.

On the other hand, when the user taps the “PICK-UP” button, the locker use unit 201 prompts the user to enter or input a pick-up point, a pick-up date and time, and the like. When the user completes these inputs via the input unit 24, the locker use unit 201 generates a pick-up request and transmits it to the server 30 via the network N1.

When the deposit request and the pick-up request are transmitted, information about deposit or pick-up of the baggage may be transmitted from the server 30. For example, information indicating that the baggage can be deposited or picked up under the condition transmitted by the user terminal 20 or information indicating that the baggage cannot be deposited or picked up under the condition transmitted by the user terminal 20 is transmitted from the server 30. The locker use unit 201 causes the output unit 25 to display an image corresponding to the information thus transmitted.

In addition, when the user deposits the baggage into the locker 18 or when the user picks up the baggage from the locker 18, the locker use unit 201 establishes communication with the communication unit 26 of the locker 18 and transmits information about the user to the locker 18. Therefore, the user terminal 20 is used as a key for unlocking the box 180 of the locker 18.

Also, when the user forgets the baggage in the locker 18, the user terminal 20 receives from the server 30 information for displaying an image indicating the presence of a forgotten item on the output unit 25 of the user terminal 20. Here, FIG, 9 is an example of the image displayed on the output unit 25 of the user terminal 20 when there is something left behind (forgotten item). The output unit 25 displays, for example, a text indicating that there is a forgotten item in the locker 18, a text prompting the user to return to take the forgotten item, and a text inquiring whether or not to return to take the forgotten item, In addition, a check box and a button for transmitting a response may be displayed so that the user is able to enter the response to an inquiry asking whether or not to return to take the forgotten item. When the user enters a response, the locker use unit 201 transmits information corresponding to the response to the server 30.

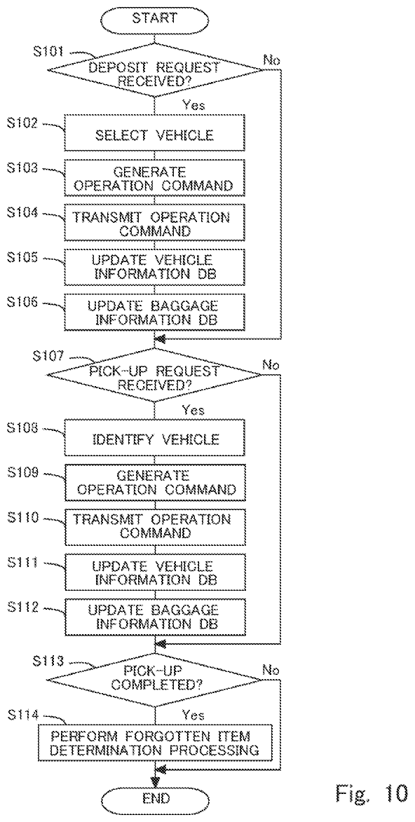

Next, baggage deposit and pick-up processing in the server 30 will be described. FIG, 10 is a flowchart of the baggage deposit and pick-up processing in the server 30 according to the present embodiment. The processing illustrated in FIG. 10 is executed at predetermined time intervals in the server 30. Note that the following description will be made on the assumption that the user information has been stored in advance in the user information DB 311.

In step S101 the baggage management part 302 determines whether or not a deposit request has been received from the user terminal 20. When an affirmative determination is made in step S101, the processing proceeds to step S102, whereas when a negative determination is made, the processing proceeds to step S107. In step S102, the baggage management part 302 selects a vehicle 10 into which the baggage of the user is deposited. Based on the information included in the deposit request and the information stored in the baggage information DB 313, the baggage management part 302 selects a vehicle 10 that is able to move to the deposit point at the deposit date and time and that has a vacant or available box 180 corresponding to the size of the user's baggage. Note that, at this time, the vehicle 10 is selected by assuming that boxes 180 for which “PRESENT” is entered in the forgotten item field are determined to be unavailable.

In step S103, the command part 303 generates an operation command so that the vehicle 10 departs from the current location and travels via the deposit point at the deposit date and time. In addition, the command part 303 authenticates the user terminal 20 at the deposit point and generates an operation command to deposit the baggage from the user. In step S104, the command part 303 transmits the operation command to the vehicle 10. Further, in step S105, the command part 303 updates the vehicle information DB 312. That is, a new route is entered into the route field.

In step S106, the baggage management part 302 updates the baggage information DB 313. That is, the baggage management part 302 enters information about the user ID, the size, the deposit point, and the deposit date and time into the baggage information DB 313.

In addition, in step S107, the baggage management part 302 determines whether or not a pick-up request has been received from the user terminal 20. When an affirmative determination is made in step S107, the processing proceeds to step S108, whereas when a negative determination is made, the processing proceeds to step S113. In step S108, the baggage management part 302 identifies the vehicle 10 in which the baggage of the user has been deposited. The baggage management part 302 identifies the vehicle 10 in which the baggage with the matching user ID is deposited, based on the information included in the pick-up request and the information stored in the baggage information DB 313.

In step S109, the command part 303 generates an operation command so that the vehicle 10 departs from the current location and travels via the pick-up point at the pick-up date and time, In addition, the command part 303 authenticates the user terminal 20 at the pick-up point and generates an operation command to deliver the baggage to the user. Then, in step S110, the command part 303 transmits the operation command to the vehicle 10. Further, in step S1 11, the command part 303 updates the vehicle information DB 312. That is, a new route is entered into the route field.

In step S112, the baggage management part 302 updates the baggage information DB 313, That is, the baggage management part 302 enters the pick-up point and the pick-up date and time into the baggage information DB 313,

In step S113, the baggage management part 302 determines whether or not the pick-up of the baggage is completed. For example, when the pick-up of the baggage is completed, information including the vehicle ID, the box number, the user ID, and the detection value of the sensor 181 is transmitted from the vehicle 10 to the server 30. When this information is received, it is determined that the pick-up of the baggage is completed. When an affirmative determination is made in step S113, the processing or routine proceeds to step S114, whereas when a negative determination is made, this routine is ended.

In step S114, the baggage management part 302 performs forgotten item determination processing to determine whether or not there is a forgotten item. The forgotten item determination processing will be described later.

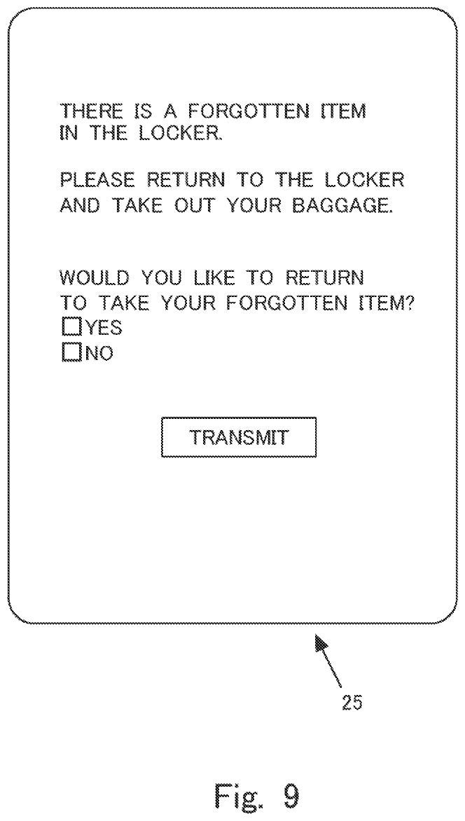

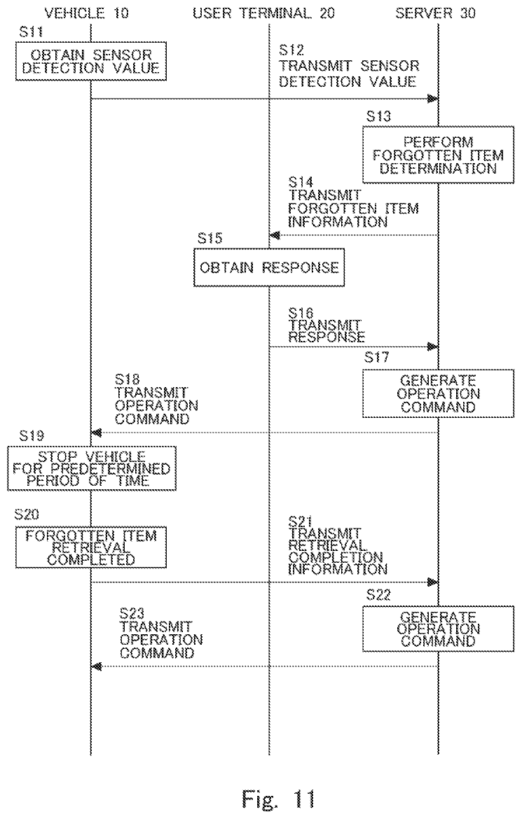

Next, an explanation will be made about the processing of the entire system 1 when there is something left behind in the locker 18 after the pick-up of the baggage is completed. FIG. 11 is a sequence diagram of the processing of the entire system 1 when there is a forgotten item in the locker 18. This processing is performed after an affirmative determination is made in step S113 of FIG. 10. Upon completion of the pick-up of the baggage by the user, the vehicle 10 obtains the detection value of the sensor 181 attached to the box 180 from which the baggage has been picked up (S11), and transmits it to the server 30 (S12). The server 30 determines, based on the detection value of the sensor 181, whether or not there is a forgotten item (S13). When the server 30 determines that there is a forgotten item, the forgotten item information is transmitted from the server 30 to the user terminal 20 (S14). The forgotten item information is information for outputting a screen illustrated in FIG. 9 to the output unit 25, and is information for notifying the user that there is a forgotten item.

The user terminal 20, which has received the forgotten item information, displays the screen illustrated in FIG. 9. When the user terminal 20 obtains the response entered by the user through the input unit 24 (S15), the response is transmitted from the user terminal 20 to the server 30 (S16). The server 30, which has received the response to return to take the forgotten item, generate an operation command for the vehicle 10 (S17). This operation command includes a command to stop the vehicle 10 in place for a predetermined period of time. The server 30 transmit the operation command thus generated to the vehicle 10 (S18).

The vehicle 10, which has received the operation command, stops for the predetermined period of time based on the operation command (S19). Then, in cases where the retrieval of the forgotten item by the user is completed while the vehicle 10 is stopped (S20), the vehicle 10 transmits retrieval completion information indicating to that effect to the server 30 (S21). Upon receiving the retrieval completion information, the server 30 generates an operation command (S22). This operation command is a command to move the vehicle 10 to the next deposit point or the next pick-up point. This command is transmitted to the vehicle 10 (S23). In accordance with this operation command, the vehicle 10 starts moving.

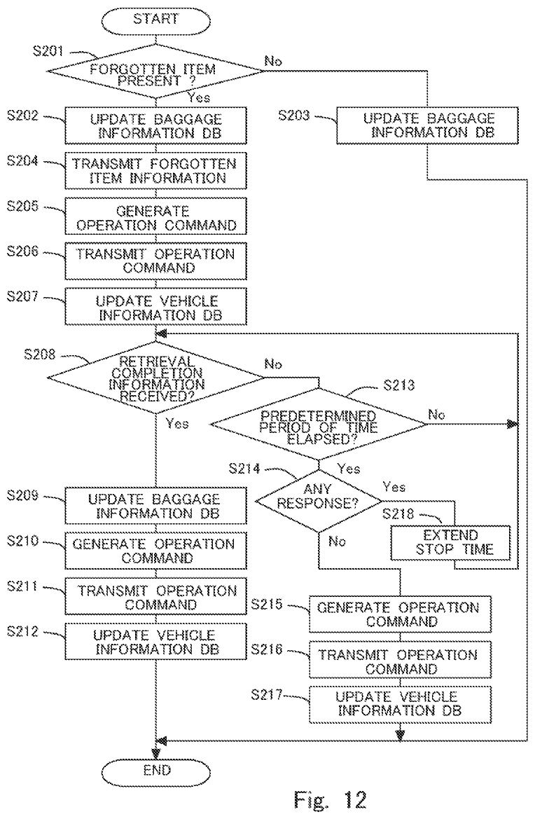

Next, the forgotten item determination processing performed in step S114 will be described. FIG. 12 is a flowchart of the forgotten item determination processing according to the first embodiment.

In step S201, the baggage management part 302 determines, based on the detection value of the sensor 181, whether or not there is a forgotten item. Here, the baggage management part 302 determines whether or not the detection value of the sensor 181 is a value when there is a forgotten item. The detection value of the sensor 181 when there is a forgotten item is stored in the auxiliary storage unit 33. When an affirmative determination is made in step S201, the processing proceeds to step S202, whereas when a negative determination is made, the processing proceeds to step S203.

In step S202, the baggage management part 302 updates the baggage information DB 313. The baggage management part 302 updates the baggage information DB 313 by entering “PRESENT” in the forgotten item field of the record corresponding to the vehicle ID and the box number associated with the detection value of the sensor 181, and by entering “NO” in the availability field of this record. Thus, the use of the box 180 with the forgotten item is prohibited.

On the other hand, in step S203, the baggage management part 302 updates the baggage information DB 313. In cases where there is no forgotten item, the baggage management part 302 resets the information stored in the fields of the user ID, the deposit point, the deposit date and time, the pick-up point, and the pick-up date and time of the record corresponding to the vehicle ID and the box number associated with the detection value of the sensor 181. Also, the baggage management part 302 enters “NOT PRESENT” in the forgotten item field of this record.

In step S204, the baggage management part 302 transmits the forgotten item information to the user terminal 20. The transmission destination of the forgotten item information is stored in the user information DB 311 in association with the user ID. In step S205, the command part 303 generates an operation command so as to maintain the stopped state of the vehicle 10, and in step S206, the command part 303 transmits the operation command thus generated to the vehicle 10. In addition, in step S207, the command part 303 updates the vehicle information DB 312. For example, information indicating that the stopped state of the vehicle 10 is maintained is entered into the status field. By keeping the vehicle 10 stopped in this manner, the user can easily find the vehicle 10 when the user returns to retrieve the forgotten item in the vehicle 10.

In step S208, the baggage management part 302 determines whether retrieval completion information has been received from the vehicle 10. When an affirmative determination is made in step S208, the processing proceeds to step S209, whereas when a negative determination is made, the processing proceeds to step S213. In step S209, the baggage management part 302 updates the baggage information DB 313. The baggage management part 302 resets the information stored in the fields of the user ID, the deposit point, the deposit date and time, the pick-up point, and the pick-up date and time of the record corresponding to the vehicle ID and the box number because the forgotten item has been retrieved. Further, “NOT PRESENT” is entered into the forgotten item field, and “YES” is entered into the availability field.

In step S210, the command part 303 generates an operation command to move to the next destination, and in step S211, the command part 303 transmits the operation command thus generated to the vehicle 10. In addition, in step S212, the command part 303 updates the vehicle information DB 312. For example, information indicating that the stopped state of the vehicle 10 is maintained is deleted from the status field.

In step S213, the baggage management part 302 determines whether or not a predetermined period of time has elapsed since the forgotten item information was transmitted. The predetermined period of time referred to herein is a period of time during which the vehicle 10 waits for the user to return to take the forgotten item. The predetermined period of time may have been determined in advance, or may be determined in time for the deposit or pick-up of baggage according to the next deposit point and the next deposit date and time, or the next pick-up point and the next pick-up date and time. For example, a period of time required for the vehicle 10 to move to the next destination may be calculated based on the distance to the next destination and the average speed of the vehicle 10, and the predetermined period of time may be determined such that the vehicle 10 starts to move at a time point earlier than the next reserved time point by the period of time required for the movement. When an affirmative determination is made in step S213, the processing proceeds to step S214, whereas when a negative determination is made, the processing proceeds to step S208.

In step S214, the baggage management part 302 determines whether or not a response to the forgotten item information has been received from the user terminal 20. Here, there is a response from the user terminal 20 as to whether or not to return to the vehicle 10 to retrieve the forgotten item, and it is determined whether or not the response indicates that the user will return to the vehicle 10 to retrieve the forgotten item, When such a response is received from the user, the stopped state of the vehicle 10 is maintained in order to wait for the user even after the predetermined period of time set in step S213 has elapsed. Accordingly, when an affirmative determination is made in step S214, the processing proceeds to step S218, whereas when a negative determination is made, the processing proceeds to step S215.

Here, note that, as an alternative, in step S214, the baggage management part 302 may determine whether or not the user is on the way back to the vehicle 10 to retrieve the forgotten item. For example, it may be determined, based on the position information of the user terminal 20, whether or not the user returns to the vehicle 10, and when it is determined that the user will return to the vehicle 10, the stop time of the vehicle 10 may be extended. In this case, for example, the position information of the user terminal 20 may be obtained at predetermined intervals, and the direction of movement of the user may be estimated from the transition or change of the position information. Then, if the direction of movement of the user is in the direction of approaching the vehicle 10, it may be determined that the user is returning to the vehicle 10. In addition, as another alternative, it may be determined that the user returns to the vehicle 10 when the user begins to move in the opposite direction along the route on which the user has moved.

In step S218, the baggage management part 302 extends the stop time of the vehicle 10. For example, by increasing the predetermined period of time in step S213, the stop time of the vehicle 10 is extended. The period of time to be extended at this time is set to, for example, a period of time that does not affect the deposit and pick-up of baggage of other users, or that there is no problem even if there is an influence. Alternatively, the period of time until the user returns to the vehicle 10 may be calculated based on the position information of the user terminal 20, and the stop time of the vehicle 10 may be extended by this period of time

In step S215, the command part 303 generates an operation command to move to the next destination, and in step S216, the command part 303 transmits the operation command thus generated to the vehicle 10. In addition, in step S217, the command part 303 updates the vehicle information DB 312. For example, information indicating that the stopped state of the vehicle 10 is maintained is deleted from the status field.

In this way, it is possible to continue depositing and delivering the baggage of other users while leaving the forgotten item in the locker 18, but as an alternative, the forgotten item may be collected at the management center. In this case, in step S215, the command part 303 may generate an operation command so that the vehicle 10 moves to, for example, the management center for collecting the forgotten item. For example, in cases where the number of boxes 180 reserved by users cannot be secured if the box 180 cannot be used due to the forgotten item, the vehicle 10 may be moved to the management center In addition, the timing of moving the vehicle 10 to the management center is not limited to immediately after the user has forgotten the item, but may also be after the deposit and delivery of baggage of other users are completed.

As described above, according to the first embodiment, when a user forgets an item in a box 180 of the locker 18, the user is notified to that effect, so that the user can be encouraged to return to retrieve the forgotten item. As a result, the operating rate of the box 180 can be increased.

### Second Embodiment

In the above-described first embodiment, when there is a forgotten item, the user is notified via the user terminal 20, and the vehicle 10 is stopped to wait until the user returns. On the other hand, in a second embodiment, the vehicle 10 directly notifies the user via a speaker or the like. The notification via the user terminal 20 described in the first embodiment may be used in combination. In addition, in the first embodiment, the vehicle 10 is stopped to wait for the user to return. On the other hand, in the second embodiment, the vehicle 10 moves based on the position information of the user terminal 20, so that the vehicle 10 delivers the forgotten item to the user.

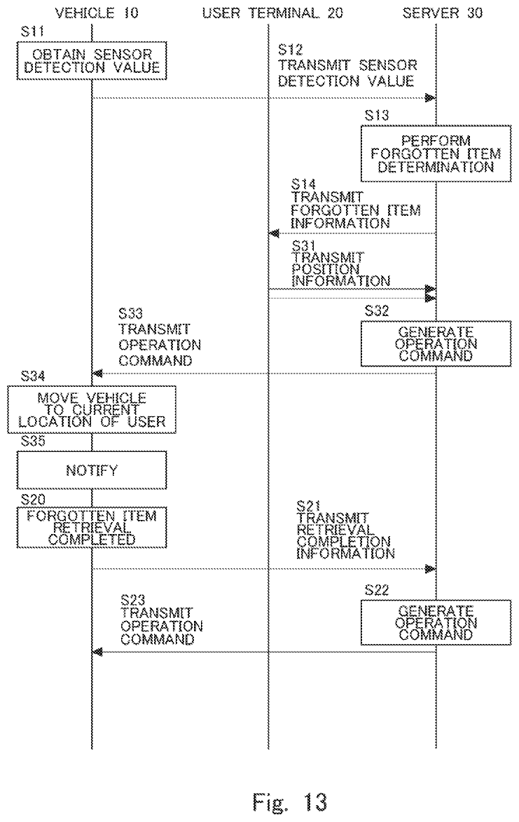

FIG. 13 is a sequence diagram of the processing of the entire system 1 when there is a forgotten item in the locker 18. This processing is performed after an affirmative determination is made in step S113 of FIG. 10. Here, note that steps in which the same processing as in FIG. 11 is executed will be denoted by the same reference signs, and the description thereof will be omitted. When forgotten item information is transmitted from the server 30 to the user terminal 20 (S14), position information is periodically transmitted from the user terminal 20 a plurality of times (S31). Here, note that the user terminal 20, which has received the forgotten item information, may notify the user that there is a forgotten item. In this case, a screen indicating that there is a forgotten item may be displayed, or vibration or sound may be generated.

On the basis of the position information received from the user terminal 20, the server 30 generate an operation command so that the vehicle 10 moves toward the user (S32). The operation command includes a command to notify the user when the vehicle 10 comes near the user. For example, the server 30 may generate a route to the current location of the user terminal 20, and transmit the route to the vehicle 10. In this case, since it is conceivable that the user may move further after the route is generated, for example, the route to the current location of the user terminal 20 may be periodically generated and transmitted to the vehicle 10. As an alternative, the route of the user may be predicted from the transition of the position information of the user terminal 20, and the route of the vehicle 10 may be generated such that the vehicle 10 passes on the route of the user thus predicted.

The operation command generated by the server 30 is transmitted to the vehicle 10 (S33). The vehicle 10 starts to move toward the current location of the user terminal 20 (S34). Then, when the vehicle 10 approaches the current location of the user terminal 20, the speaker of the vehicle 10 notifies the user that there is a forgotten item, for example (S35). Further, when the vehicle 10 approaches the user, it stops and waits for the user to take out the forgotten item.

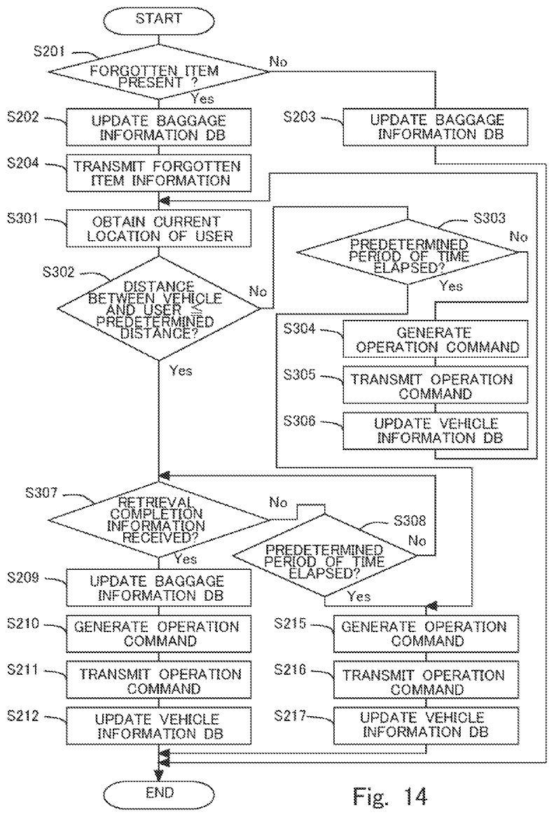

Next, the forgotten item determination processing performed in step S114 will be described. FIG. 14 is a flowchart of the forgotten item determination processing according to the second embodiment. Here, note that steps in which the same processing as in FIG. 12 is executed will be denoted by the same reference signs, and the description thereof will be omitted. In addition, in the following description, it is assumed that position information is periodically transmitted from the user terminal 20 to the server 30. In the flowchart illustrated in FIG. 14, when the processing in step S204 is completed, the processing or routine proceeds to step S301. In step S301, the command part 303 obtains the current location of the user. Specifically, the command part 303 obtains the current location received from the user terminal 20 as the current location of the user.

In step S302, the command part 303 determines whether or not the distance between the vehicle 10 and the user is equal to or less than a predetermined distance. The predetermined distance is a distance at which the user can notice the notification of the vehicle 10. The command part 303 calculates the distance between the vehicle 10 and the user based on the current location of the vehicle 10 and the current location of the user terminal 20. When an affirmative determination is made in step S302, the processing proceeds to step S307, whereas when a negative determination is made, the processing proceeds to step S303.

In step S303, the command part 303 determines whether or not a predetermined period of time has elapsed since the forgotten item information was transmitted to the user terminal 20. The predetermined period of time referred to herein is a period of time in which there is a risk that the vehicle will not be in time for deposit or pick-up of the baggage of the next user. Here, it is not preferable that the deposit or pick-up of the baggage of the next user be delayed in order to deliver the forgotten item. Therefore, in cases where the distance between the vehicle 10 and the user does not become equal to or less than the predetermined distance even after the predetermined period of time elapses, the vehicle 10 gives up the delivery of the forgotten item and moves to the deposit point or the pick-up point of the baggage of the next user. Accordingly, when an affirmative determination is made in step S303, the processing proceeds to step S215, whereas when a negative determination is made, the processing proceeds to step S304.

In step S304, the command part 303 generates an operation command so that the vehicle 10 moves to the current location of the user and the user is notified of the presence of the forgotten item from the speaker of the locker 18 when the vehicle 10 enters within a predetermined range of the current location of the user. The operation command includes a route along which the vehicle 10 moves to the current location of the user. In step S305, the command part 303 transmits the operation command thus generated to the vehicle 10. In addition, in step S306, the command part 303 updates the vehicle information DB 312. For example, information about the route generated in step S304 is entered into the route field.

On the other hand, in step S307, the baggage management part 302 determines whether or not pick-up completion information has been received from the vehicle 10. When an affirmative determination is made in step S307, the processing proceeds to step S209, whereas when a negative determination is made, the processing proceeds to step S308. In step S308, the baggage management part 302 determines whether or not a predetermined period of time has elapsed since the forgotten item information was transmitted to the user terminal 20. The predetermined period of time referred to herein is a period of time in which there is a risk that the vehicle will not be in time for deposit or pick-up of the baggage of the next user. That is, in cases where the user does not pick up receive the forgotten item for some reason, there is a concern that the vehicle 10 may not be in time for deposit or pick-up of the baggage of the next user. Therefore, the vehicle 10 gives up the delivery of the forgotten item, and moves to the deposit point or the pick-up point of the baggage of the next user. Accordingly, when an affirmative determination is made in step S308, the processing proceeds to step S215, whereas when a negative determination is made, the processing returns to step S307.

As described above, according to the second embodiment, since the vehicle 10 follows the user who has forgotten something, the user can quickly receive the forgotten item. This allows a new user to deposit his or her baggage.

### Third Embodiment

In the above-described second embodiment, the vehicle 10 moves based on the position information of the user terminal 20, so that the vehicle 10 delivers the forgotten item to the user. On the other hand, in a third embodiment, a delivery point of the forgotten item is proposed to the user, and the vehicle 10 is moved to the proposed point to deliver the forgotten item. Here, note that the predetermined or proposed point where the delivery of the forgotten item is performed is a point where the vehicle 10 meets the user, and may be, for example, a point where the vehicle 10 can stop between the current location of the vehicle 10 and the current location of the user. In addition, a plurality of points may be proposed so that the user can select among them.

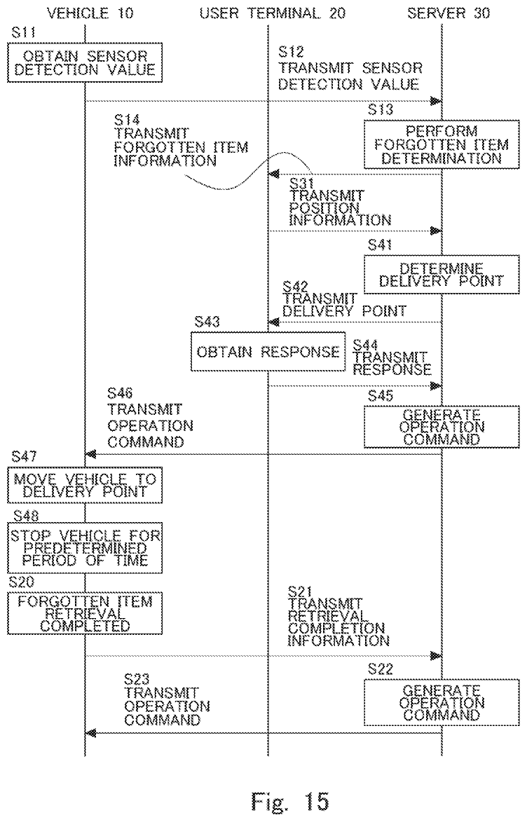

FIG. 15 is a sequence diagram of the processing of the entire system 1 when there is a forgotten item in the locker 18. This processing is performed after an affirmative determination is made in step S113 of FIG. 10. Here, note that steps in which the same processing as in FIG. 11 or FIG. 13 is executed will be denoted by the same reference signs, and the description thereof will be omitted. The server 30 determines, based on the detection value of the sensor 181, whether or not a forgotten item exists (S13), and when determining that a forgotten item exists, the server 30 transmits forgotten item information to the user terminal 20 (S14). The forgotten item information includes information for displaying on the screen of the user terminal 20 an image indicating that there is a forgotten item, and information for instructing the user terminal 20 to transmit its position information. The user terminal 20, which has received the forgotten item information, transmits its position information to the server 30 (S31). Here, note that, as an alternative, in cases where the position information is periodically transmitted from the user terminal 20 to the server 30, the processing of step S14 may be omitted. Further, it is not essential for the user terminal 20 having received the forgotten item information to notify the user that there is a forgotten item. That is, the forgotten item information may be information for causing the user terminal 20 to transmit the position information.

Upon receiving the position information from the user terminal 20, the server 30 determines the delivery point of the forgotten item based on the position information (S41). For example, the server 30 determines, as the delivery point, a point where the vehicle 10 can be stopped around the current location of the user terminal 20. At this time, the delivery point may be determined only within a range in which the user can move on foot. In addition, as an alternative, a point at which the vehicle 10 can be stopped between the current location of the vehicle 10 and the current location of the user terminal 20 may be determined as the delivery point. At this time, a plurality of delivery points may be determined. Further, as another alternative, a route along which the user will move may be predicted, and a point around the predicted route at which the vehicle 10 can be stopped may be determined as the delivery point.

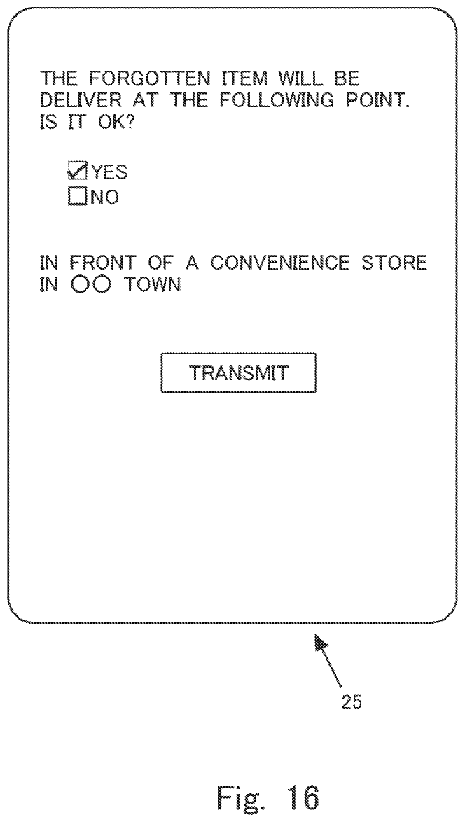

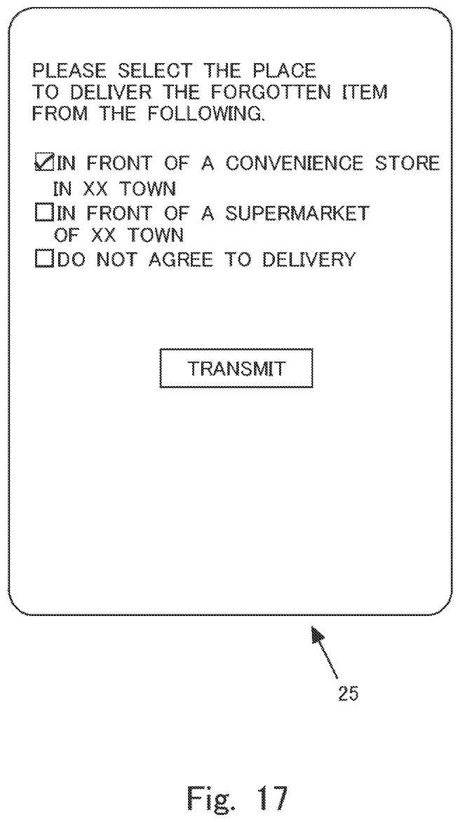

The server 30 transmits the delivery point thus determined to the user terminal 20 (S42). At the user terminal 20, a screen is displayed for determining whether or not to agree to deliver the baggage at the determined delivery point and for selecting the delivery point. FIG. 16 is an example of an image displayed on the screen of the user terminal 20 that has received information about the delivery point, FIG. 16 illustrates the image displayed on the screen of the user terminal 20 at the time of inquiring whether or not the user wants to have his or her baggage delivered at a delivery location in cases where only the one delivery location has been determined. On the other hand, FIG. 17 is another example of an image displayed on the screen of the user terminal 20 that has received information about delivery points. FIG. 17 illustrates the image displayed on the screen of the user terminal 20 at the time of inquiring at which of a plurality of delivery locations (points) the user wants to have his or her baggage delivered in cases where the plurality of delivery locations have been determined. The user terminal 20 obtains a response entered by the user in accordance with this screen (S43), and transmits it to the server 30 (S44).

At the server 30, an operation command is generated based on the response received from the user terminal 20, so that the vehicle 10 moves toward the delivery point of the forgotten item (S45). For example, a route to the delivery point may be generated and transmitted to the vehicle 10. This operation command includes a command to notify the user when the vehicle 10 comes near the user.

The operation command generated by the server 30 is transmitted to the vehicle 10 (S46). The vehicle 10 starts to move toward the delivery point (S47). Then, when the vehicle 10 approaches the delivery point, the user is notified of the presence of the forgotten item from the speaker of the vehicle 10 (S48). Thereafter, upon arriving at the delivery point, the vehicle 10 is stopped for a predetermined period of time. When the user does not come to pick up the forgotten item even after the vehicle 10 stops for a predetermined period of time, the vehicle 10 moves toward the next user.

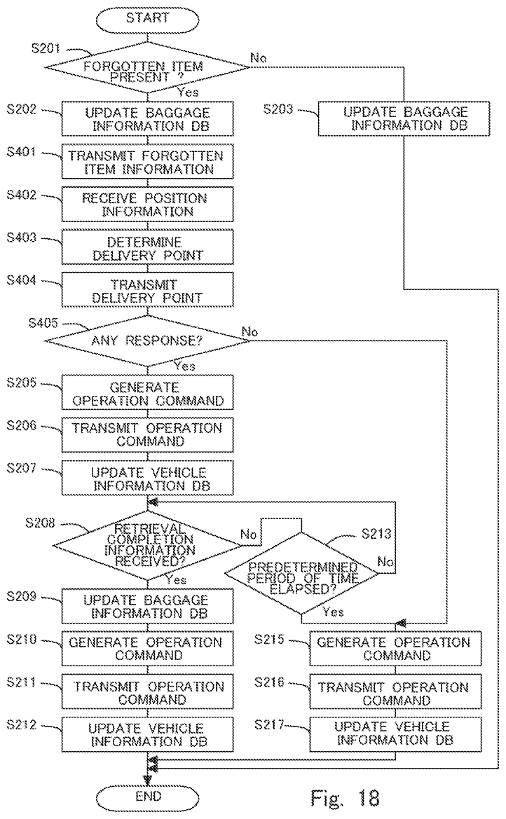

Next, the forgotten item determination processing performed in step S114 will be described. FIG. 18 is a flowchart of the forgotten item determination processing according to the third embodiment. Here, note that steps in which the same processing as in FIG. 12 is executed will be denoted by the same reference signs, and the description thereof will be omitted. In the flowchart illustrated in FIG. 18, when the processing in step S202 is completed, the processing or routine proceeds to step S401

In step S401, the baggage management part 302 transmits forgotten item information to the user terminal 20. The forgotten item information transmitted here may include information for notifying the user of the presence of a forgotten item. In step S402, the command part 303 obtains the current location of the user. Specifically, the command part 303 obtains the current location received from the user terminal 20 as the current location of the user.

In step S403, the baggage management part 302 determines the delivery point. For example, a point which is within a range in which the user can move on foot from the current location obtained from the user terminal 20 and at which the vehicle 10 can be stopped is extracted based on the data stored in the map information DB 314. In cases where there are a plurality of corresponding points, a plurality of delivery points may be determined, so that the user may be allowed to select from among them. Alternatively, the current location obtained from the user terminal 20 may be determined as the delivery point.

In step S404, the baggage management part 302 transmits information about the delivery point thus determined to the user terminal 20. The information about the delivery point includes information for enabling the user to move to that point (e.g., information about coordinates, an address, a name, a description of the point, or the like). In addition, the information to be transmitted to the user terminal 20 includes a command or instruction for displaying an inquiry about the delivery point on the screen of the user terminal 20 and transmitting its response to the server 30.

In step S405, the baggage management part 302 determines whether or not a response as to the delivery point has been received from the user terminal 20. Here, the baggage management part 302 determines whether or not there is a response as to which delivery point the forgotten item is to be delivered at. When an affirmative determination is made in step S405, the processing proceeds to step S205, whereas when a negative determination is made, the processing proceeds to step S215. Note that in cases where there is no response from the user terminal 20 even after waiting for a predetermined period of time, it may be treated as if there is no response from the user terminal 20.

Here, note that in the above description, when the user forgets something, the delivery point is determined immediately, but as an alternative, the delivery point may be determined after waiting for a predetermined period of time. For example, it is conceivable that the user may notice a forgotten item and return to the vehicle 10. If the vehicle 10 is moving at this time, it will be difficult for the user to find the vehicle 10. Therefore, the vehicle 10 may remain stationary during the time in which the user may return.

As described above, according to the third embodiment, the user can promptly receive the forgotten item because the user and the vehicle 10 meet up to deliver the forgotten item to the user. This allows a new user to deposit his or her baggage.

### Other Embodiments

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner, For example, the server 30 may include a part of the functions of the vehicle 10. Also, for example, the vehicle 10 may include a part or all of the functions of the server 30.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
notifying a user when it is detected that baggage remains in a compartment after the user uses a service of keeping the baggage in a storage device which is mounted on a vehicle and which has a plurality of compartments in which the baggage can be deposited by the user.

2. The information processing apparatus according to claim 1, wherein
the controller transmits information about the notification to a terminal of the user.

3. The information processing apparatus according to claim 1, wherein
the controller keeps the vehicle stopped until a predetermined condition is satisfied in the case of notifying the user.

4. The information processing apparatus according to claim 3, wherein
the predetermined condition is that a predetermined period of time has elapsed since the notification to the user.

5. The information processing apparatus according to claim 3, wherein
the controller keeps the vehicle stopped when receiving, from a terminal of the user, information about the user returning to the vehicle, even if the predetermined condition is satisfied,

6. The information processing apparatus according to claim 5, wherein
the information about the user returning to the vehicle includes a response from the terminal of the user to the notification.

7. The information processing apparatus according to claim 5, wherein
the information about the user returning to the vehicle includes position information of the terminal of the user.

8. The information processing apparatus according to claim 1, wherein
the controller moves the vehicle based on position information obtained from a terminal of the user when notifying the user.

9. The information processing apparatus according to claim 8, wherein
the controller transmits, to the terminal of the user. information about a point at which the baggage is to be delivered, when moving the vehicle based on the position information obtained from the terminal of the user.

10. The information processing apparatus according to claim 1, wherein
the controller moves the vehicle to a predetermined point at which the baggage is collected, in cases where the baggage is not picked up by the user.

11. An information processing method for causing a computer to perform:
notifying a user when it is detected that baggage remains in a compartment after the user uses a service of keeping the baggage in a storage device which is mounted on a vehicle and which has a plurality of compartments in which the baggage can be deposited by the user.

12. The information processing method according to claim 11, wherein
the computer transmits information about the notification to a terminal of the user.

13. The information processing method according to claim 11, wherein
the computer keeps the vehicle stopped until a predetermined condition is satisfied in the case of notifying the user.

14. The information processing method according to claim 13, wherein
the predetermined condition is that a predetermined period of time has elapsed since the notification to the user.

15. The information processing method according to claim 13, wherein
the computer keeps the vehicle stopped when receiving, from a terminal of the user, information about the user returning to the vehicle, even if the predetermined condition is satisfied.

16. The information processing method according to claim 15, wherein
the information about the user returning to the vehicle includes a response from the terminal of the user to the notification.

17. The information processing method according to claim 15, wherein
the information about the user returning to the vehicle includes position information of the terminal of the user.

18. The information processing method according to claim 11, wherein
the computer moves the vehicle based on position information obtained from a terminal of the user when notifying the user.

19. The information processing method according to claim 18, wherein
the computer transmits, to the terminal of the user, information about a point at which the baggage is to be delivered, when moving the vehicle based on the position information obtained from the terminal of the user.

20. The information processing method according to claim 11, wherein
the computer moves the vehicle to a predetermined point at which the baggage is collected, in cases where the baggage is not picked up by the user.
